(19) United States
(12) Patent Application Publication
(10) Pub. No.: US 2025/0208025 A1
(43) Pub. Date: Jun. 26, 2025

(54) DEVICE AND METHOD FOR CHARACTERIZING A PARTICLE

(71) Applicant: Q.ant GmbH, Stuttgart (DE)

(72) Inventors: Helge Hattermann, Pliezhausen (DE); Michael Förtsch, Ansbach (DE)

(21) Appl. No.: 19/078,319

(22) Filed: Mar. 13, 2025

Related U.S. Application Data
(63) Continuation of application No. PCT/EP2023/074918, filed on Sep. 11, 2023.

(30) Foreign Application Priority Data
Sep. 14, 2022 (DE) 10 2022 123 464.9

(51) Int. Cl. G01N 15/14; G01N 15/1434

(52) U.S. Cl. CPC G01N 15/1459; G01N 15/1434; G01N 2015/1454

(57) ABSTRACT

A device for characterizing a particle includes a light source for projecting a light beam along a beam axis, a beam shaper arranged configured to adjust a location-dependent intensity distribution of the light beam in a measurement volume which extends partly along the beam axis, and a detector configured to detect a measurement beam reflected and/or scattered by the particle when the particle is located in the measurement volume, and to output at an intensity signal to an analyzer. The analyzer is configured to determine a particle characteristic within the measurement volume based on the intensity signal. The beam shaper is configured to shape the location-dependent intensity distribution in a projection plane, which extends within the measurement volume transversely to the beam axis, such that an intensity of the light beam is minimal along an outer contour of an oval and is maximal at one point within the oval.

### CROSS REFERENCE TO RELATED APPLICATIONS

This application is a continuation of International Application No. PCT/EP2023/074918 (WO 2024/056612 A1), filed on Sep. 11, 2023, and claims benefit to German Patent Application No. DE 10 2022 123 464.9, filed on Sep. 14, 2022. The aforementioned applications are hereby incorporated by reference herein.

### FIELD

Embodiments of the present invention relate to a device and a method for characterizing a particle.

### BACKGROUND

A device and a method of the types mentioned at the outset are known per se and are used in various applications in order to determine a particle characteristic, such as a particle position, a particle velocity or, for example, a particle size. This information can be used, for example, to monitor or control industrial manufacturing and machining processes.

A device for determining the particle characteristic is known, for example, from DE 10 2019 209 213 A1 and comprises a light source by means of which a light beam is projected along a beam axis. A beam-shaping optical unit is arranged along the beam axis. The beam-shaping optical unit is designed to adjust a location-dependent intensity distribution of the light beam in a measurement volume which extends partly along the beam axis. A particle to be characterized, which is located in the measurement volume, reflects or scatters the light beam at least partially as a measurement beam. This measurement beam is detected by a detector, which outputs an intensity signal to an analysis unit. The analysis unit is used to determine the particle characteristic within the measurement volume on the basis of the intensity signal.

### SUMMARY

Embodiments of the present invention provide a device for characterizing a particle. The device includes a light source for projecting at least one light beam along a beam axis, a beam shaper arranged along the beam axis and configured to adjust a location-dependent intensity distribution of the light beam in a measurement volume which extends partly along the beam axis, and at least one detector configured to detect at least one measurement beam reflected and/or scattered by the particle when the particle is located in the measurement volume, and to output at least one intensity signal to an analyzer. The analyzer is configured to determine a particle characteristic within the measurement volume based on the intensity signal. The beam shaper is configured to shape the location-dependent intensity distribution in a projection plane, which extends within the measurement volume transversely to the beam axis, such that an intensity of the light beam is minimal along an outer contour of an oval and is maximal at least one point within the oval.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a device for characterizing a particle according to some embodiments;

FIG. 2 shows a first exemplary embodiment of a location-dependent intensity distribution with a location-dependent polarization distribution;

FIG. 3 shows a diagram with a plurality of polarization-dependent intensity courses for determining a particle position according to some embodiments;

FIG. 4 shows a second exemplary embodiment of a location-dependent intensity distribution;

FIG. 5 shows a third exemplary embodiment of a location-dependent intensity distribution; and

FIG. 6 shows a fourth exemplary embodiment of a location-dependent intensity distribution.

### DETAILED DESCRIPTION

It is desirable to be able to characterize the particle within the measurement volume with a high degree of accuracy. An increase in accuracy compared to the previously known device is possible, for example, by increasing the power of the light source used, but this is typically associated with high costs. Embodiments of the invention provide a device and a method which are associated with a good ratio between the achievable accuracy for characterizing a particle and the resulting costs.

Embodiments of the present invention provide a device that has a light source for projecting at least one light beam along a beam axis. A beam-shaping optical unit is arranged along the beam axis and is designed to adjust a location-dependent intensity distribution of the light beam in a measurement volume which extends partly along the beam axis. A detector is used to detect a measurement beam reflected and/or scattered by a particle in the measurement volume and to output at least one intensity signal to an analysis unit. The analysis unit is designed to determine a particle characteristic within the measurement volume on the basis of the intensity signal.

The device according to embodiments of the invention differs from previously known devices in that the beam-shaping optical unit is designed to shape the location-dependent intensity distribution in a projection plane, which extends within the measurement volume transversely to the beam axis, such that an intensity of the light beam is minimal along an outer contour of an oval and is maximal at least one point within the oval.

Embodiments of the invention are based on the finding that adjusting the location-dependent intensity distribution, in which the light beam has a basic oval shape in the projection plane, is associated with increased accuracy in determining the particle characteristic in a larger spatial area. Compared to a radially symmetrical intensity distribution, in which the intensity of the light beam is minimal, for example, along a circular contour, the intensity distribution extends over a greater length along the vertical axis of the oval and over a smaller length along the transverse axis of the oval. In addition, the light beam can be more focused along the vertical axis than along the transverse axis. Compared to previously known devices, the light beam can therefore have an overall higher power per unit area for the same light source power in the projection plane. This means that the light beam can be reflected and/or scattered by a particle in the measurement volume with a correspondingly higher intensity. It is possible to characterize a particle with a high spatial resolution in a large spatial area, in particular along the vertical axis of the oval.

Advantageously, the intensity of the light beam is maximal at least at a surface center point of the oval, wherein in particular a Gaussian intensity distribution can be present. The intensity decreases continuously from the surface center point towards the outer contour of the oval. In particular, the oval has a vertical axis and a transverse axis, in relation to which the oval is respectively designed as symmetrical and has a larger dimension along the vertical axis than along the transverse axis. Preferably, the oval is an ellipse and, in particular, not a circle.

The particle characteristic can be, for example, a dimension of the particle or, preferably, a particle position along the vertical axis of the oval in the projection plane. In particular, the device is designed such that the particle position along the vertical axis can be determined with a spatial resolution of 1 micrometer. Preferably, the detector has a spatial resolution from 5 micrometers to 0.1 micrometers within the measurement volume, particularly preferably from 3 micrometers to 1 micrometer, most preferably 1 micrometer.

The particle can be a solid that is located in a gas, a vacuum or a liquid. It can also be a drop of oil in a water bath or, conversely, a drop of water in an oil bath. It can also be a liquid droplet in a gas or vacuum or, in particular, a liquid droplet that emerges from a nozzle, in particular from a spray nozzle.

Embodiments of the invention are not limited to a specific embodiment of the light source. In a simple embodiment, the light source comprises at least one laser with a laser diode, a superluminescent diode, a halogen illuminant or a comparable optical beam source.

According to some embodiments of the invention, at least the light source and the detector can be present in a transmission arrangement or in a reflection arrangement. In the transmission arrangement, the light source and the detector are arranged on different sides of the projection plane. Here, the light beam is scattered by the particle to be characterized such that the measurement beam is present as a transmission beam. In the reflection arrangement, the light source and the detector are arranged on the same side in relation to the projection plane. The light beam is reflected by the particle to be characterized such that the measurement beam is present as a reflection beam. According to some embodiments of the invention, at least two detectors are provided, wherein a first detector and the light source are arranged on different sides of the projection plane and wherein a second detector and the light source are arranged on one side of the projection plane. In such an embodiment, a combination of a reflection arrangement and a transmission arrangement between the light source and the detector is provided.

The beam-shaping optical unit can comprise a cylindrical lens in which a lens surface is curved in one axis and by means of which the intensity distribution of the light beam according to embodiments of the invention can be adjusted. The detector can comprise a collector lens, by means of which the measurement beam is bundled and directed onto at least one sensor element of the detector. In particular, the sensor element is a photodiode which emits an electrical signal to the analysis unit when the measurement beam is detected and the amplitude of which is preferably dependent on the intensity of the measurement beam.

Preferably, at least the light source and the beam-shaping optical unit are arranged in a fixed position along the beam axis and, in particular, in a defined alignment to one another. At least in a reflection arrangement, the detector is preferably arranged with a measurement axis, along which the measurement beam can be detected, at an angle to the beam axis of the light beam.

The analysis unit can be designed as an electrical computing unit by means of which the particle characteristic can be determined. A mathematical model, which describes an analytically or empirically determined relationship between the intensity of the measurement beam and the particle characteristic, can be implemented on the analysis unit. By measuring the intensity of the measurement beam, the intensity signal output by the detector can be assigned to the particle characteristic to be determined using the mathematical model.

Additionally or alternatively, discrete table values can be stored on the analysis unit, by means of which a measured intensity value of the measurement beam can be compared with a stored intensity value and assigned to the associated particle characteristic.

Additionally or alternatively, at least one characteristic curve can be stored in the analysis unit, which indicates an intensity course on the basis of the extent of a particle characteristic. Using the characteristic curve, a measured intensity of the measurement beam can be assigned to the particle characteristic to be determined. In particular, the characteristic curve describes a course of an intensity of the measurement beam on the basis of a particle position along an axis in the projection plane, in particular the vertical axis of the oval.

In an advantageous further development, the beam-shaping optical unit is designed to adjust a location-dependent polarization distribution in the projection plane in addition to the location-dependent intensity distribution, wherein a first polarization and a second polarization with different polarization directions are present along the vertical axis of the oval. The detector is designed to determine at least two intensities of the measurement beam, which has the first polarization and/or the second polarization, and to output two polarization-dependent intensity signals to the analysis unit. The analysis unit is designed to determine the particle characteristic on the basis of the two polarization-dependent intensity signals.

The further development described above is based on the finding of the applicant that the intensity of the measurement beam can be simultaneously dependent on multiple particle characteristics, for example a particle position and a particle size. This makes it difficult to clearly determine only one of these particle characteristics, as, for example, a varying particle size between different particles to be characterized with the same particle position can lead to different measurable intensities. Due to the design of the beam-shaping optical unit, by means of which a location-dependent intensity distribution and a location-dependent polarization distribution can be adjusted in the projection plane, a further light property of the light beam can be adjusted and taken into account. This makes it possible to take into account not only the intensity of the measurement beam, but also the polarization in order to be able to determine a unique particle characteristic, in particular a particle position. Such an embodiment of the intensity distribution and the polarization distribution means that the measurement beam reflected and/or scattered by the particle can have at least two intensity components of different polarization.

For a better understanding, please refer to the following example for the position determination of three particles: If a first particle is located in the measurement volume and scatters or reflects the light beam with a first intensity and a first polarization, the first intensity and the first polarization can be assigned to a first particle position. If a second particle is located in the measurement volume and scatters or reflects the light beam with a second intensity, which is higher than the first intensity, and a second polarization, it can be concluded that the second particle is in a second position. If a third particle is located in the measurement volume and scatters or reflects the light beam with the second intensity and the first polarization, it can be concluded that the third position of the third particle corresponds to the first position of the first particle and the second intensity is due to a larger particle dimension.

In a simple embodiment, the beam-shaping optical unit can comprise a so-called retardation plate, which generates the desired location-dependent polarization distribution with the first and second polarization directions. Such a retardation plate is an optical component that can change the polarization and phase of passing light waves as required. Preferably, the retardation plate is designed as a so-called spatial polarization converter, which is known, for example, from EP 2705393 B1 and can be manufactured according to the method known from US 20200408953 A1. Alternatively, the location-dependent polarization distribution can also be generated using a so-called spatial light modulator or a so-called vortex plate.

The detector can, for example, comprise two photodiodes, each of which has a polarization filter in order to enable polarization-sensitive triggering. A first photodiode can be designed such that it outputs a first electrical signal on the basis of the intensity of the measurement beam with the first polarization. A second photodiode can be designed such that it outputs a second electrical signal on the basis of the intensity of the measurement beam with a second polarization.

In a simple embodiment, a mathematical model can be implemented in the analysis unit in the manner already described, which assigns a large number of intensity values of different polarizations to a corresponding number of particle characteristics, in particular particle positions. In particular, the analysis unit can have a stored analysis routine by means of which at least two intensity values of different polarizations are set in relation to one another and this ratio is assigned to a particle position using a mathematical model and/or a table and/or a characteristic curve. Instead of the above-mentioned ratio, a metric corresponding to the ratio can also be determined.

In an advantageous further development, the beam-shaping optical unit is designed to generate the location-dependent polarization distribution such that there is an angle of 180 degrees between the polarization directions of the first polarization and the second polarization. Along the vertical axis of the oval, preferably in the region of the point within the oval at which the intensity is maximal, at least one third polarization is present. An angle of 90 degrees is present in each case between the polarization directions of the first polarization and the third polarization and/or between the polarization directions of the second polarization and the third polarization.

The further development described above allows for a further increase in accuracy when determining the particle characteristic. In this regard, the beam-shaping optical unit is designed to adjust the third polarization. Furthermore, the detector is designed to detect an intensity of the measurement beam with the third polarization. The analysis unit is further designed to determine the particle characteristic on the basis of three intensity signals at the first, second and third polarization.

In a further advantageous further development, the beam-shaping optical unit is designed to generate the location-dependent polarization distribution such that a fourth polarization is present along the vertical axis of the oval and between the first polarization and the third polarization and/or between the second polarization and the third polarization, wherein an angle of 45 degrees is present between the polarization directions of the fourth polarization and the third polarization.

The further development described above allows for a further increase in accuracy when determining the particle characteristic. In this regard, the beam-shaping optical unit is designed to adjust the fourth polarization. Furthermore, the detector is designed to detect an intensity of the measurement beam with the fourth polarization. The analysis unit is further designed to determine the particle characteristic on the basis of four intensity signals at the first, second and third and fourth polarization.

In an advantageous further development, the detector is designed such that the polarization-dependent intensity components of the measurement beam can be determined in at least two of the following polarizations: 0 degrees, 45 degrees, 90 degrees, 135 degrees.

The further development described above is advantageous because the polarization directions mentioned can be easily adjusted using common beam-shaping optical units. The detector can have a plurality of photodiodes with at least two polarization filters, which are arranged relative to one another such that light from the photodiodes is only detected in the polarization directions of the polarization filters.

Preferably, there is no phase difference or a phase difference of 180° between the parts of the light beam that have different polarization directions. This makes it easy to adjust a linear polarization. However, investigations by the applicant have also shown that adjusting a circular or elliptical polarization is also advantageous in order to be able to clearly determine a particle characteristic, in particular a particle position. In an advantageous further development, the light source and/or the beam-shaping optical unit is/are therefore designed to generate at least two light beams with a phase difference, wherein the phase difference is 90 degrees in order to adjust a circular polarization in the projection plane at least in regions or wherein the phase difference is between 0 degrees and 90 degrees or between 90 degrees and 180 degrees in order to adjust an elliptical polarization in the projection plane at least in regions.

In a further advantageous further development, the light source and/or the beam-shaping optical unit is/are designed to shape the location-dependent intensity distribution in the projection plane such that the intensity of the light beam along two outer contours of two ovals, the vertical axes of which are arranged in a V-shape relative to one another, is minimal and that the intensity distribution in the regions of the vertical axes of the two ovals is maximal. The detector is designed to detect the intensities of two measurement beams in a time-shifted manner. The analysis unit is used to determine a particle position within the measurement volume on the basis of a time interval between the measured intensities of the two measurement beams.

The further development described above is based on the finding of the applicant that the embodiment of the location-dependent intensity distribution of the light beam, in which the intensity along the outer contour of an oval is minimal, can be multiplied in the projection plane in order to be able to reliably determine a particle characteristic, in particular a particle position. When a particle crosses the measurement volume in the projection plane and crosses the vertical axes of the two ovals, two measurement beams are reflected and/or scattered in a time-shifted manner to one another and detected by the detector with a corresponding time shift. If the angle between the vertical axes arranged in a V-shape relative to one another is known and the particle velocity is known, the particle position can be determined by taking into account the time interval between the two intensity signals. This further development is particularly advantageous if the particle velocities of multiple particles to be characterized do not differ and are known.

Alternatively, the device can be designed such that the intensity of the light beam along three outer contours of three ovals, the vertical axes of which are arranged in an N-shape to one another, is minimal and that the intensity distribution in the regions of the vertical axes of the three ovals is maximal. The detector is designed to detect the intensities of three measurement beams in a time-shifted manner. The analysis unit is used to determine a particle position within the measurement volume on the basis of at least two time intervals between the measured intensities of the three measurement beams.

One advantage of the further development described above is that the particle position within the measurement volume can be determined independently of a particle velocity. In particular, the particle position can be determined on the basis of a ratio of the two time intervals. It is a finding of the applicant that the determination of such a ratio of the two time intervals enables a reliable determination of the particle position even with varying and unknown particle velocities.

In a further advantageous further development, the light source and/or the beam-shaping optical unit is/are designed to project two light beams with different wavelengths along a respective beam axis, which overlap in the projection plane and thereby have the location-dependent intensity distribution and a location-dependent wavelength distribution. The detector is designed to detect at least one wavelength-dependent intensity of the measurement beam. The analysis unit is designed to determine a particle position within the measurement volume on the basis of the wavelength-dependent intensities of the measurement beam.

With the location-dependent wavelength distribution, a further light property can be taken into account in addition to the intensity of the measurement beam in order to be able to clearly determine a particle characteristic. In particular, the location-dependent wavelength distribution can be used in addition or as an alternative to a location-dependent polarization distribution in order to be able to clearly determine a particle position within the measurement volume. The location-dependent intensity distribution can be designed as symmetrical in relation to the vertical axis and the transverse axis of the oval. The location-dependent wavelength distribution can, for example, be different along the vertical axis at two spaced apart positions. Such an embodiment of the intensity distribution and the wavelength distribution means that the light beam reflected by the particle in the form of the measurement beam can have at least two wavelength components, the consideration of which allows for the position of the particle to be clearly determined within the projection plane.

The detector can have multiple photodiodes that are designed to be wavelength-sensitive such that a detected measurement beam with different wavelength components leads to different signal amplitudes of the corresponding photodiodes. The wavelength-dependent signals can be evaluated using a mathematical model, a table or a characteristic curve in order to determine the particle characteristic, in particular the particle position.

In an advantageous further development, the measurement volume has a length along the beam axis that corresponds to twice the Rayleigh length of the light beam.

The Rayleigh length describes, in a manner known per se, the distance along the beam axis between the focal plane and a position at which its cross-sectional area doubles in relation to the focal plane. Therefore, the dimensions and/or the position of the measurement volume in relation to the beam axis can be adjusted on the basis of the properties of the light beam, in particular its focal plane.

Preferably, the beam-shaping optical unit and/or the detector is/are designed to form the measurement volume depending on the application and with adjustable dimensions. Preferably, the oval in the projection plane has a height of between 10 micrometers and 1000 micrometers and/or a width of between 100 micrometers and 5 centimeters.

One advantage of determining the particle position on the basis of a plurality of polarization-dependent intensity values is particularly that no camera system is required. Instead, the particle position can be determined on the basis of discrete values, wherein both the detector and the analysis unit can be of a simple design. Investigations by the applicant have shown that the analysis unit can be designed to determine a plurality of particle positions with a frequency above 10 MHz.

In an advantageous further development, the light source and/or the beam-shaping optical unit and/or the detector is/are arranged in a fixed position in relation to one another in order to form the measurement volume in a stationary manner and to detect a moving particle in the measurement volume. Alternatively, the light source and/or the beam-shaping optical unit and/or the detector is/are arranged movably in order to displace the measurement volume by means of a scanning movement and to detect a particle at rest in the measurement volume. Preferably, the light source and/or the beam-shaping optical unit and/or the detector is/are arranged immovably relative to one another during the scanning movement.

The scanning movement can be implemented by means of kinematics known per se, for example an articulated arm robot or a comparable device. In such an embodiment of the device, surfaces in particular can be examined in order to determine whether they are contaminated with one or more particles.

Embodiments of the invention also provide a method for characterizing a particle, in which a light beam is projected along a beam axis, wherein the light beam has a location-dependent intensity distribution in a measurement volume which extends partly along the beam axis. A particle to be characterized reflects or scatters the light beam in the measurement volume at least partially as a measurement beam. A particle characteristic within the measurement volume is determined on the basis of at least one intensity of the measurement beam.

It is essential for the method that the location-dependent intensity distribution in a projection plane, which extends within the measurement volume transversely to the beam axis, is minimal along an outer contour of an oval and is maximal at least one point within the oval, in particular a surface center point of the oval.

Preferably, the method can be carried out by means of the device according to embodiments of the invention or an advantageous further development thereof. Accordingly, the same explanations that have already been provided above with regard to the device according to embodiments of the invention and the advantageous further developments apply with regard to the advantages that can be achieved here.

In an advantageous further development, the light beam is generated with a location-dependent polarization distribution and the particle characteristic is determined on the basis of a polarization-dependent intensity of the measurement beam.

In another advantageous further development, the light beam is generated with different wavelengths which overlap in the measurement volume, wherein the overlapping light beams have the location-dependent intensity distribution and a location-dependent wavelength distribution in the projection plane and wherein the particle to be characterized within the measurement volume is determined on the basis of a wavelength-dependent intensity of the measurement beam.

In a further advantageous further development, the location-dependent intensity distribution in the projection plane is generated such that the intensity of the light beam along an outer contour of two ovals, the vertical axes of which are arranged in a V-shape, is minimal and is maximal in the regions of the vertical axes of the two ovals. The particle to be characterized reflects or scatters the light beam in the measurement volume at least partially as two measurement beams. The intensities of the two measurement beams are detected in a time-shifted manner. The particle characteristic, in particular a particle position, is determined within the measurement volume on the basis of a time interval between two measured intensities of the measurement beams.

Alternatively, the location-dependent intensity distribution in the projection plane is generated such that the intensity of the light beam along an outer contour of three ovals, the vertical axes of which are arranged in an N-shape, is minimal and is maximal in the regions of the vertical axes of the three ovals. The intensities of the three measurement beams are detected in a time-shifted manner. The particle characteristic within the measurement volume is determined on the basis of two time intervals between the measured intensities of the measurement beams and preferably independently of a particle velocity.

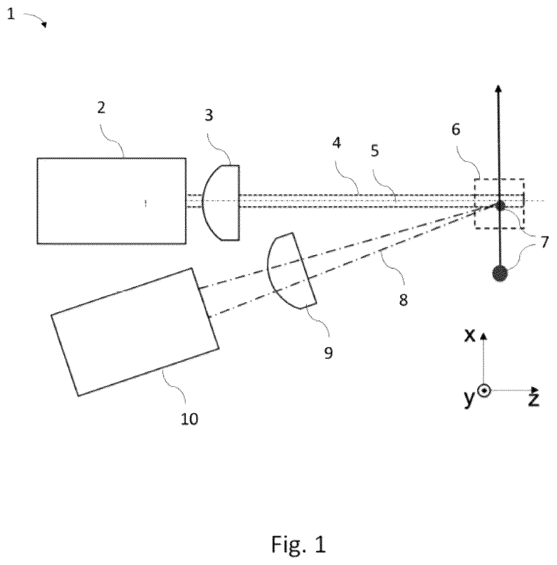

FIG. 1 shows a device 1 by means of which a particle position can be determined optically. For this purpose, the device 1 has a laser 2 and a beam-shaping optical unit 3, which comprises a vortex plate and a cylindrical lens in a manner not shown here.

The laser 2 is used to generate a light beam 4, which extends along a beam axis 5. A section of the light beam 4 along the beam axis 5 serves as the measurement volume 6 in the present case, which is passed through by a moving particle 7. According to FIG. 1, the particle 7 is shown in two positions during a linear movement.

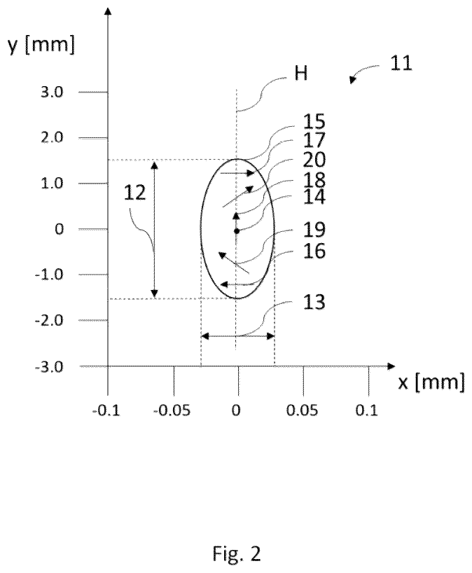

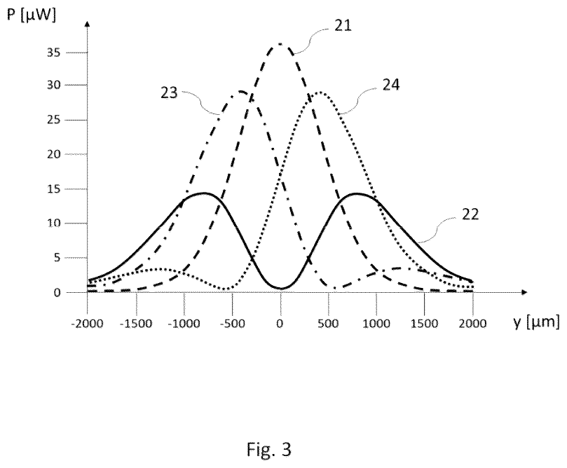

As shown in detail in FIGS. 2 and 3, the beam-shaping optical unit 3 with the cylindrical lens and the vortex plate is used to adjust a location-dependent intensity distribution and a location-dependent polarization distribution of the light beam 4 in a projection plane that extends perpendicular to the beam axis 5.

The particle 7 located in the measurement volume 6 reflects the light beam 4 at least partially in the form of a measurement beam 8, which is collected by the collector lens 9 and directed to a detector 10. The measurement beam 8 has a plurality of polarization-dependent intensities that can be determined by the detector 10.

An analysis unit, which is integrated into the detector 10 in the exemplary embodiment shown here, is used to determine the desired particle position within the measurement volume 6 on the basis of at least one polarization-dependent intensity of the measurement beam 8.

As shown in FIG. 2, the light beam in the projection plane substantially has the shape of an oval 11 with two axes of symmetry, i.e., an ellipse. Along a vertically extending vertical axis H, the oval has a height dimension 12 that is greater than a width dimension 13 along a horizontally extending transverse axis. The intensity of the light beam is distributed in such a way that it is maximal at the surface center point 14 of the oval 11 and minimal along an outer contour 15. Within the oval 11, there exists a two-dimensional Gaussian intensity distribution in a plane perpendicular to the projection plane. In other words, the intensity extends continuously in a region between the surface center point 14 and the circumferential outer contour 15, wherein the intensity decreases starting from the surface center point 14 in a radial direction towards the outer contour 15.

Such an intensity distribution means that the light beam can be reflected with different intensities along the vertical axis H of the oval. By measuring the intensity of the measurement beam, a particle characteristic can be determined with a high degree of accuracy. If the particle characteristic to be determined is a particle position, it is advantageous to take into account that the intensity of the measurement signal can also vary on the basis of the particle size. Therefore, the embodiment of the intensity distribution shown in FIG. 2 provides for the beam-shaping optical unit to generate a location-dependent polarization distribution, which is indicated in FIG. 2 by the arrows 16, 17, 18, 19 and 20. Here, a first polarization 16 and a second polarization 17 are present along the vertical axis H, which are spaced apart from one another along the vertical axis H of the oval 11 and the polarization directions of which are at an angle of 180 degrees to one another. A third polarization 18 is present in the region of the surface center point 14, the polarization direction of which has a polarization angle of 90 degrees to the polarization directions of the first and second polarization. Between the first polarization 16 and the third polarization 18, there is a fourth polarization 19, the polarization direction of which is at an angle of 45 degrees to the polarization direction of the third polarization 18. Between the second polarization 17 and the third polarization 18, there is a fifth polarization 20, which also has an angular difference of 45 degrees compared to the third polarization 18. Contrary to the illustration shown, the location-dependent polarization distribution is continuous along the vertical axis H and comprises the discretely shown polarizations 16, 17, 18, 19 and 20.

If the particle 7 is located in the projection plane and in the region of the vertical axis H of the oval 11, the light beam is reflected such that the measurement beam has a plurality of intensity components of different polarization. Taking these polarization-dependent intensity components into account makes it possible to determine a clear position of the particle within the projection plane.

FIG. 3 shows a diagram with the location-dependent intensity courses 21, 22, 23 and 24. These intensity courses each describe the polarization-dependent intensity of the light beam along the vertical axis of the oval in its projection plane. Here, the first intensity course 21 corresponds to the location-dependent intensity of the light beam with the first polarization 18 according to FIG. 2. The second intensity course 22 corresponds to the location-dependent intensity of the light beam with the second polarization 16 and the third polarization 17 according to FIG. 2. The polarization directions of the polarizations 16 and 17 have an angle of 180 degrees so that a polarization filter is permeable to light with both polarizations 16, 17. The third intensity course 23 corresponds to the location-dependent intensity of the light beam with the fourth polarization 19 according to FIG. 2. The fourth intensity course 24 corresponds to the location-dependent intensity of the light beam with the fifth polarization 20 according to FIG. 2.

If a particle is located in the projection plane of the light beam, which corresponds to the image plane of FIG. 2, the reflected measurement beam has a plurality of polarization-dependent intensities which, depending on the y-position of the particle, correspond to the intensity courses 21, 22, 23 and 24 according to FIG. 3. For example, if the particle is located at a height of 0 μm along the y-axis, the measurement beam has a dominant intensity component that corresponds to the first intensity course 21 and has the corresponding first polarization 18. At the same time, the measurement beam in this example has less pronounced intensity components that correspond to the intensity courses 23 and 24 and have the corresponding fourth polarization 19 and fifth polarization 20. In other words, at the y-position of 0 μm, the polarization 18 according to FIG. 2 predominates, but this can be represented by linear superposition of equal parts of the polarizations 19 and 20 according to FIG. 2.

By measuring the polarization-dependent intensities using the detector 10, these can be assigned to a clear position of the particle along the y-axis using a mathematical model or a table, for example. Here, the asymmetrical course of the intensity courses 23, 24 in particular allows for a clear distinction between two particle positions along the y-axis.

In the exemplary embodiment of the device 1 shown in FIG. 1, the light is split into two beams with a so-called 50:50 beam splitter, independent of polarization. Two photodiodes, which are designed to detect different polarization components, are arranged behind this beam splitter along the optical path. In this regard, a first photodiode is designed to detect the polarizations 18, 16 and 17 according to FIG. 2. The second photodiode is designed to detect the polarizations 19 and 20. Measurement beam. When the split measurement beam is detected, the photodiodes each output an electrical signal that corresponds to the intensity of the corresponding measured light component of one of the polarizations mentioned. The signals are evaluated in the analysis unit, for example using the mathematical model mentioned above.

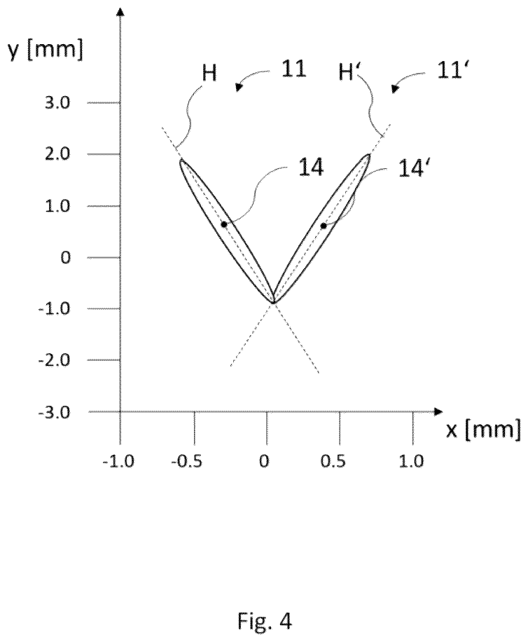

FIG. 4 shows an alternative embodiment of the intensity distribution in the projection plane, which can be shaped by means of a device that substantially corresponds to the device 1 according to FIG. 1. In contrast to the embodiment shown in FIG. 1, the light source is designed to shape the location-dependent intensity distribution in the projection plane such that the intensity along an outer contour of two ovals 11, 11′, the vertical axes H, H′ of which are arranged in a V-shape, is minimal and that the intensity in the regions of the vertical axes H, H′, in the present case in the surface center points 14, 14′ of the two ovals 11 or 11′, is maximal. The detector is designed to detect the intensities of two measurement beams in a time-shifted manner. The analysis unit is designed to determine a particle position within the measurement volume on the basis of a time interval between the measured intensities of the two measurement beams.

The intensity distribution shown in FIG. 4 extends along the x-axis over a range of approximately 1 mm. In an alternative embodiment, the extension along the x-axis can be up to 3 mm. When a particle moving through the measurement volume parallel to the x-axis crosses the projection plane x-y and crosses the vertical axes H, H′ of the two contiguous ovals 11, 11′, two measurement beams are reflected in a time-shifted manner to one another and detected by the detector with a corresponding time shift. With a known angle between the V-shaped vertical axes H, H′ and a known particle velocity, a particle position can be determined by taking the measured intensities into account. The application of this further development is particularly advantageous if the particle velocities of multiple particles to be characterized are known and do not differ. In this regard, it is possible to directly deduce a particle position based on the measured time interval.

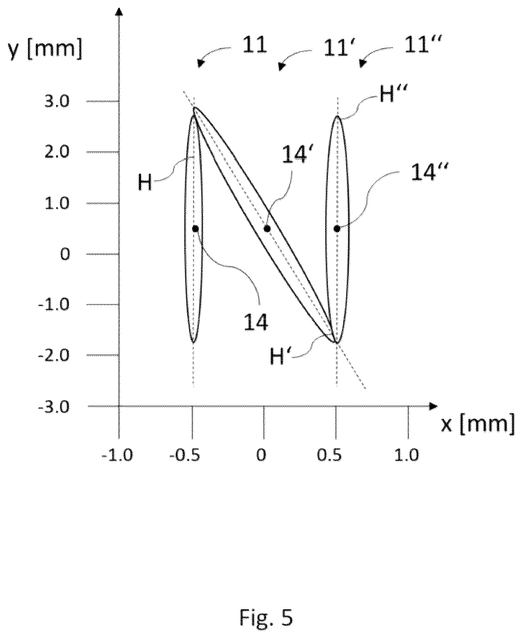

FIG. 5 shows an alternative embodiment of the intensity distribution in the projection plane, which can be shaped by means of a device that substantially corresponds to the device 1 according to FIG. 1. In contrast to the device shown in FIG. 1, the light source is designed to shape the location-dependent intensity distribution in the projection plane such that the intensity along an outer contour of three ovals 11, 11′, 11″, the vertical axes H, H′, H″ of which are arranged in an N-shape, is minimal and that the intensity in the regions of the vertical axes H, H′, H″, in the present case in the surface center points 14, 14′ and 14″ of three ovals 11, 11′ and 11″, respectively, is maximal, wherein the detector is designed to detect the intensities of three measurement beams in a time-shifted manner and wherein the analysis unit is designed to determine a particle position within the measurement volume on the basis of two time intervals between the two measured intensities of the measurement beams and, in particular, independently of a particle velocity. The intensity distribution shown in FIG. 5 extends along the x-axis over a range of approximately 1 mm. In an alternative embodiment, the extension along the x-axis can be up to 3 mm.

One advantage of the intensity distribution shown in FIG. 5 is that the particle position within the measurement volume can be determined independently of the particle velocity.

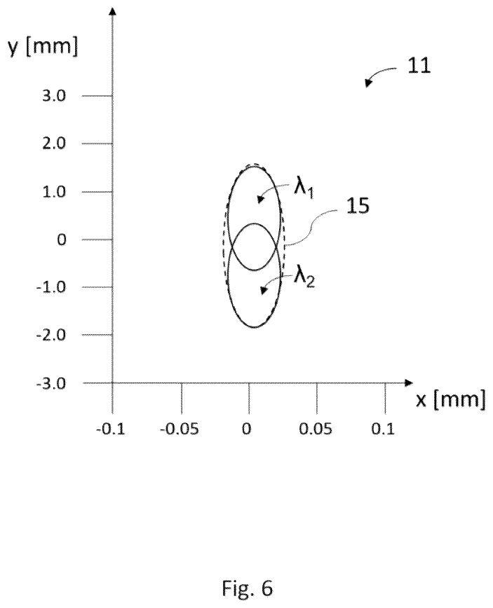

FIG. 6 shows a further embodiment of the device, in which the light source 2 is designed to project two light beams with different wavelengths 21, 22 along a respective beam axis, which overlap in the projection plane x-y and thereby have the location-dependent intensity distribution and a location-dependent wavelength distribution, and wherein the detector is designed to detect at least one wavelength-dependent intensity of the measurement beam and to output a wavelength-dependent intensity signal to the analysis unit, wherein the analysis unit is designed to determine a particle position within the measurement volume on the basis of the wavelength-dependent intensity signal.

With the location-dependent wavelength distribution, a further light property can be taken into account in addition to the intensity of the measurement beam in order to be able to clearly determine a particle characteristic. In particular, the location-dependent wavelength distribution can be used in addition or as an alternative to a location-dependent polarization distribution in order to be able to clearly determine a particle position within the measurement volume. The embodiment of the intensity distribution and the wavelength distribution shown in FIG. 6 means that the light beam reflected or scattered by the particle in the form of the measurement beam can have at least two wavelength components, the consideration of which allows for the position of the particle to be clearly determined within the projection plane.

The detector can have multiple photodiodes that are designed to be wavelength-sensitive such that a detected reflection beam with different wavelength components leads to different signal amplitudes of the corresponding photodiodes. The wavelength-dependent signals can be evaluated using a mathematical model, a table or a characteristic curve in order to determine the particle characteristic, in particular the particle position.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A device for characterizing a particle, the device comprising:
a light source for projecting at least one light beam along a beam axis,
a beam shaper arranged along the beam axis and configured to adjust a location-dependent intensity distribution of the light beam in a measurement volume which extends partly along the beam axis, and
at least one detector configured to detect at least one measurement beam reflected and/or scattered by the particle when the particle is located in the measurement volume, and to output at least one intensity signal to an analyzer,
wherein the analyzer is configured to determine a particle characteristic within the measurement volume based on the intensity signal,
wherein
the beam shaper is configured to shape the location-dependent intensity distribution in a projection plane, which extends within the measurement volume transversely to the beam axis, such that an intensity of the light beam is minimal along an outer contour of an oval and is maximal at least one point within the oval.

2. The device according to claim 1, wherein the intensity of the light beam is maximal at a surface center point of the oval.

3. The device according to claim 1, wherein:
the beam shaper is configured to adjust a location-dependent polarization distribution in the projection plane, wherein at least a first polarization and a second polarization with different polarization directions are present along a vertical axis of the oval, and
the detector is configured to determine at least two intensities of the measurement beam, which has the first polarization and/or the second polarization, and to output two polarization-dependent intensity signals to the analyzer, and
the analyzer is configured to determine the particle characteristic based on the at least two polarization-dependent intensity signals.

4. The device according to claim 3, wherein the particle characteristic comprises a particle position.

5. The device according to claim 3, wherein:
the beam shaper is configured to generate the location-dependent polarization distribution such that there is an angle of 180 degrees between the polarization directions of the first polarization and the second polarization, and
at least one third polarization is present along the vertical axis of the oval, wherein an angle of 90 degrees is present between the polarization direction of the first polarization and a direction of the third polarization and/or between the polarization direction of the second polarization and the direction of the third polarization.

6. The device according to claim 5, wherein:
the beam shaper is configured to generate the location-dependent polarization distribution such that a fourth polarization is present along the vertical axis of the oval and between the first polarization and the third polarization and/or between the second polarization and the third polarization, wherein an angle of 45 degrees is present between a direction of the fourth polarization and the direction of the third polarization.

7. The device according to claim 6, wherein:
the detector is configured to determine the at least two intensities of the measurement beam in at least two of the following polarizations: 0 degrees, 45 degrees, 90 degrees, or 135 degrees.

8. The device according to claim 3, wherein the light source and/or the beam shaper is configured to generate at least two light beams with a phase difference therebetween, and
wherein the phase difference is 90 degrees in order to adjust a circular polarization in the projection plane at least in regions, or
wherein the phase difference is between 0 degrees and 90 degrees or between 90 degrees and 180 degrees in order to adjust an elliptical polarization in the projection plane at least in the regions.

9. The device according to claim 1, wherein:
the light source and/or the beam shaper is/are configured to shape the location-dependent intensity distribution in the projection plane such that the intensity of the light beam along two outer contours of two ovals, the vertical axes of which are arranged in a V-shape, is minimal, and that the intensity of the light beam in regions of the vertical axes of the two ovals is maximal,
the detector is configured to detect intensities of two measurement beams in a time-shifted manner, and
the analyzer is configured to determine a particle position within the measurement volume at least based on a time interval between the intensities of the two measurement beams.

10. The device according to claim 1, wherein:
the light source and/or the beam shaper is/are configured to shape the location-dependent intensity distribution in the projection plane such that the intensity of the light beam along three outer contours of three ovals, the vertical axes of which are arranged in an N-shape, is minimal, and that the intensity of the light beam in regions of the vertical axes of the three ovals is maximal,
the detector is configured to detect intensities of three measurement beams in a time-shifted manner, and
the analyzer is configured to determine a particle position within the measurement volume based on two time intervals between the intensities of the three measurement beams.

11. The device according to claim 1, wherein:
the light source and/or the beam shaper is/are configured to project two light beams with different wavelengths each along a respective beam axis, which overlap in the projection plane and thereby have the location-dependent intensity distribution and a location-dependent wavelength distribution,
the detector is configured to detect at least one wavelength-dependent intensity of the measurement beam and to output a wavelength-dependent intensity signal to the analyzer, and
the analyzer is configured to determine a particle position within the measurement volume based on the wavelength-dependent intensity signal.

12. The device according to claim 1, wherein the detector has a spatial resolution from 5 micrometers to 0.1 micrometers within the measurement volume.

13. The device according to claim 1, wherein:
the light source and/or the beam shaper is/are arranged immovably in order to form the measurement volume in a stationary manner, or
the light source, and/or the beam shaper, and/or the detector is/are arranged movably in order to displace the measurement volume by at least one scanning movement.

14. A method for characterizing a particle, the method comprising:
projecting a light beam along a beam axis,
wherein the light beam has a location-dependent intensity distribution in a measurement volume which extends partly along the beam axis, and
wherein the particle to be characterized reflects or scatters the light beam in the measurement volume at least partially as a measurement beam, and
determining a particle characteristic within the measurement volume based on at least one intensity of the measurement beam,
wherein the location-dependent intensity distribution in a projection plane, which extends transversely to the beam axis within the measurement volume, has an intensity that is minimal along an outer contour of an oval and is maximal at least one point within the oval.

15. The method according to claim 14, wherein the light beam has a location-dependent polarization distribution, and the particle characteristic is determined based on a polarization-dependent intensity of the measurement beam.

16. The method according to claim 14, wherein:
two light beams with different wavelengths are generated, the two light beams overlap in the measurement volume, wherein the two light beams have the location-dependent intensity distribution and a location-dependent wavelength distribution in the projection plane, and
the particle characteristic within the measurement volume is determined based on a wavelength-dependent intensity of the measurement beam.

17. The method according to claim 14, wherein:
the location-dependent intensity distribution in the projection plane is generated such that the intensity of the light beam along an outer contour of three ovals, the vertical axes of which are arranged in an N-shape, is minimal, and is maximal in regions of the vertical axes of the three ovals, and
the particle to be characterized reflects or scatters the light beam in the measurement volume at least partially as three measurement beams, wherein intensities of the three measurement beams are detected in a time-shifted manner, and
the particle characteristic is determined based on two time intervals between the intensities of the measurement beams.
